(19) United States
(12) Patent Application Publication
(10) Pub. No.: US 2006/0130542 A1
(43) Pub. Date: Jun. 22, 2006

(54) Lock device having a carrying function

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/072,421

(22) Filed: Mar. 7, 2005

(30) Foreign Application Priority Data
Dec. 21, 2004 (TW) 093220588

(51) Int. Cl. E05B 67/02

(52) U.S. Cl. 70/52

(57) ABSTRACT

A lock device includes a lock body operable between a locked state and an unlocked state, a housing mounted on a side of the lock body and having an inside formed with an insertion slot, and a carrier slidably inserted into the insertion slot of the housing. Thus, the carrier is used to support a name card, a key, an illumination assembly or other tiny article, thereby enhancing the versatility of the lock device.

### BACKGROUND OF THE INVENTION

1. Field of the Invention

The present invention relates to a lock device, and more particularly to a lock device having a carrying function to carry an article, such as a name card or the like.

2. Description of the Related Art

A conventional lock device in accordance with the prior art was disclosed in the Taiwanese Patent Publication No. 366941, entitled by “LOCK DEVICE HAVING A NAME PLATE ATTACHED THERETO”. Thus, the conventional lock device provides an identification function by provision of the name plate. However, the name plate cannot be removed from the lock body easily, thereby causing inconvenience to a user when needing to remove the name plate from the lock body.

### SUMMARY OF THE INVENTION

The present invention is to mitigate and/or obviate the disadvantage of the conventional lock device.

The primary objective of the present invention is to provide a lock device having a carrying function to carry an article, such as a name card or the like.

Another objective of the present invention is to provide a lock device, wherein the name card provided with a personal information is detachably mounted on the carrier so that the lock device has an identification function.

A further objective of the present invention is to provide a lock device, wherein the housing is made of a transparent material, so that the name card is directly viewable from the housing without having to remove the carrier from the housing.

A further objective of the present invention is to provide a lock device, wherein a tiny article, such as a key or the like, is detachably mounted on the carrier so that the lock device has a storage function.

A further objective of the present invention is to provide a lock device, wherein an illumination assembly is mounted on and supported by the carrier so that the lock device has an illuminating function.

A further objective of the present invention is to provide a lock device, wherein the carrier can be used to support a name card, a key, an illumination assembly or other tiny article, thereby enhancing the versatility of the lock device.

A further objective of the present invention is to provide a lock device, wherein when the number lock mechanism is disposed at a locked state, the carrier is locked, and when the number lock mechanism is disposed at an unlocked state, the carrier is unlocked and released.

In accordance with the present invention, there is provided a lock device, comprising:

a lock body operable between a locked state and an unlocked state;

a housing mounted on a side of the lock body and having an inside formed with an insertion slot; and

a carrier slidably inserted into the insertion slot of the housing.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lock device in accordance with the preferred embodiment of the present invention;

FIG. 2 is an exploded perspective view of the lock device as shown in FIG. 1;

FIG. 3 is a perspective view of a lock device in accordance with another preferred embodiment of the present invention;

FIG. 4 is a perspective view of a lock device in accordance with another preferred embodiment of the present invention;

FIG. 5 is an exploded perspective view of a lock device in accordance with another preferred embodiment of the present invention;

FIG. 6 is a plan cross-sectional assembly view of the lock device as shown in FIG. 5;

FIG. 7 is a schematic operational view of the lock device as shown in FIG. 6;

FIG. 8 is an exploded perspective view of a lock device in accordance with another preferred embodiment of the present invention;

FIG. 9 is an exploded perspective view of a lock device in accordance with another preferred embodiment of the present invention;

FIG. 10 is a plan cross-sectional assembly view of the lock device as shown in FIG. 9;

FIG. 11 is a schematic operational view of the lock device as shown in FIG. 10;

FIG. 12 is a perspective view of a lock device in accordance with another preferred embodiment of the present invention;

FIG. 13 is a perspective view of a lock device in accordance with another preferred embodiment of the present invention;

FIG. 14 is a schematic perspective operational view of the lock device as shown in FIG. 13;

FIG. 15 is a schematic perspective operational view of the lock device as shown in FIG. 13;

FIG. 16 is an exploded perspective view of a lock device in accordance with another preferred embodiment of the present invention;

FIG. 17 is a plan cross-sectional assembly view of the lock device as shown in FIG. 16; and

FIG. 18 is a schematic operational view of the lock device as shown in FIG. 17.

### DETAILED DESCRIPTION OF THE INVENTION

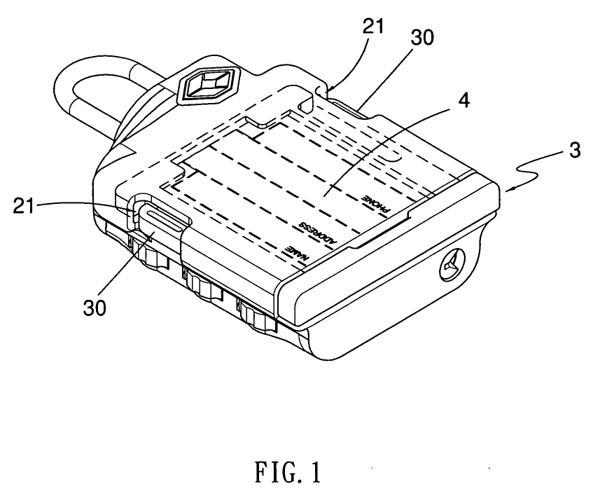

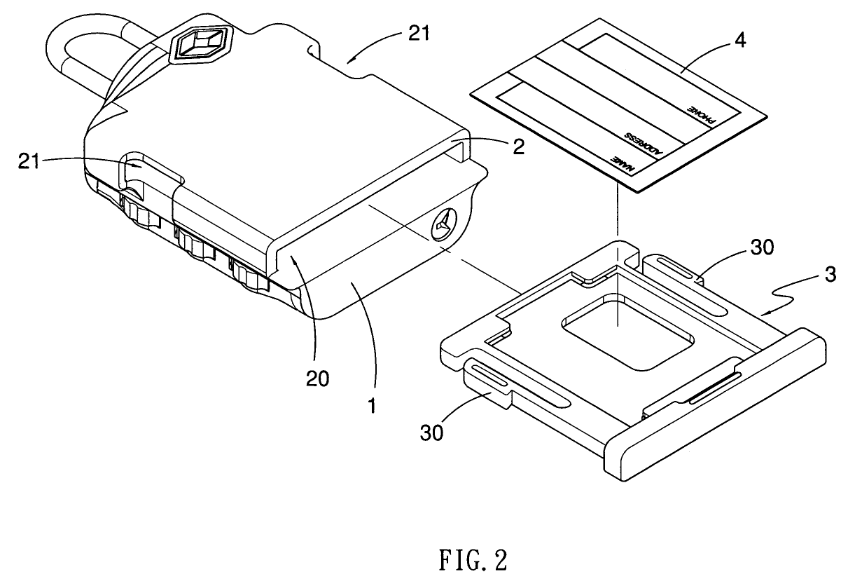

Referring to the drawings and initially to FIGS. 1 and 2, a lock device in accordance with the preferred embodiment of the present invention comprises a lock body 1, a housing 2, a carrier 3, and a name card 4.

The lock body 1 is disposed at a locked state.

The housing 2 is mounted on a side of the lock body 1 and has an inside formed with an insertion slot 20 and two opposite sides each formed with a snapping hole 21.

The carrier 3 is slidably inserted into the insertion slot 20 of the housing 2 and has two opposite sides each formed with an elastic snapping member 30 detachably snapped into the respective snapping hole 21 of the housing 2.

The name card 4 is detachably mounted on the carrier 3 and is provided with a personal information including a name, address, telephone number and the like.

As shown in FIG. 1, when the carrier 3 is inserted into the insertion slot 20 of the housing 2, the snapping member 30 of the carrier 3 is snapped into the respective snapping hole 21 of the housing 2 so that the carrier 3 will not detach from the insertion slot 20 of the housing 2 freely. In addition, the housing 2 is made of a transparent material, so that the name card 4 is viewable from the housing 2 without having to remove the carrier 3 from the insertion slot 20 of the housing 2.

When the snapping member 30 of the carrier 3 is pressed inward, the snapping member 30 of the carrier 3 is detached from the respective snapping hole 21 of the housing 2 so that the carrier 3 can be removed from the insertion slot 20 of the housing 2 freely.

In addition, the carrier 3 is used to carry the name card 4 provided with a personal information and can also be used to carry a tiny article, such as a key or the like.

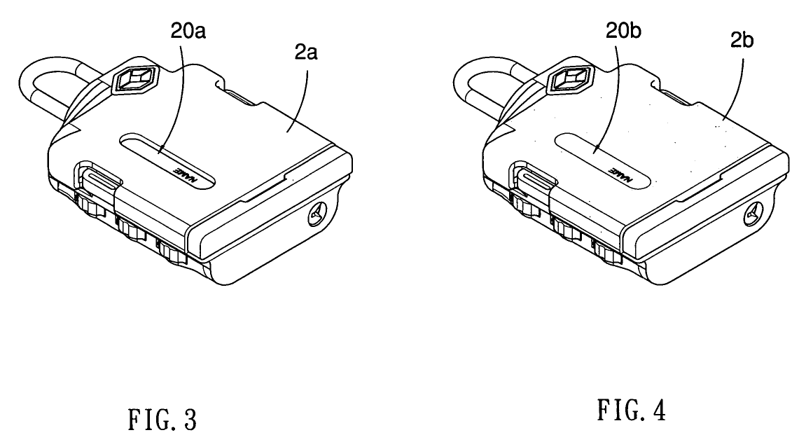

As shown in FIG. 3, the housing 2a is made of an opaque material and is formed with an elongated window 20a to facilitate inspection of the personal information.

As shown in FIG. 4, the housing 2b has a portion made of a transparent material and formed with an elongated window 20b to facilitate inspection of the personal information.

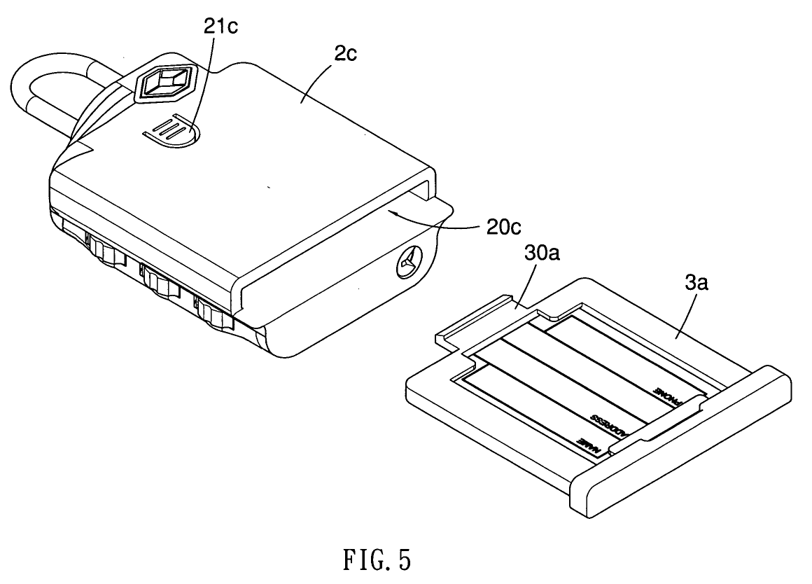

Referring to FIGS. 5-7, the housing 2c has an inside formed with an insertion slot 20c and has a wall provided with an elastic push button 21c, and the carrier 3a is slidably inserted into the insertion slot 20c of the housing 2c and provided with an elastic snapping member 30a detachably snapped onto the wall of the housing 2c and facing the push button 21c of the housing 2c.

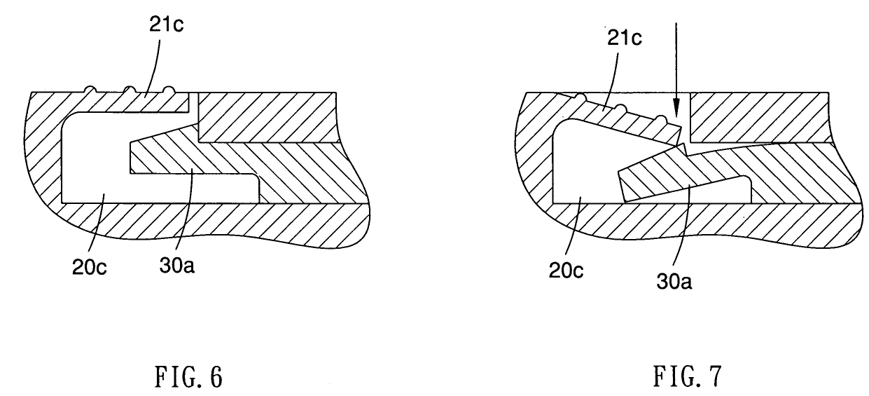

As shown in FIG. 6, when the carrier 3a is inserted into the insertion slot 20c of the housing 2c, the snapping member 30a of the carrier 3a is snapped onto the housing 2c and faces the push button 21c of the housing 2c.

As shown in FIG. 7, when the push button 21c of the housing 2c is pressed inward to press the snapping member 30a of the carrier 3a, the snapping member 30a of the carrier 3a is moved to detach from the housing 2c so that the carrier 3a can be removed from the insertion slot 20c of the housing 2c freely.

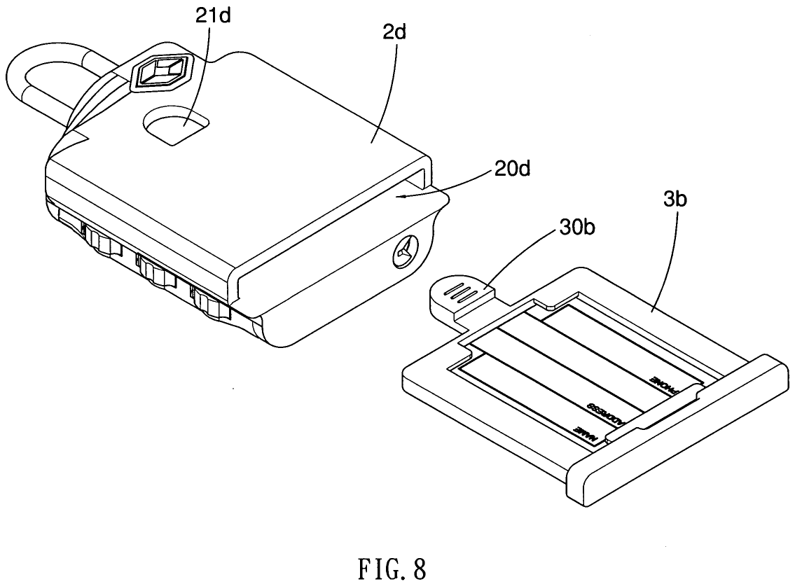

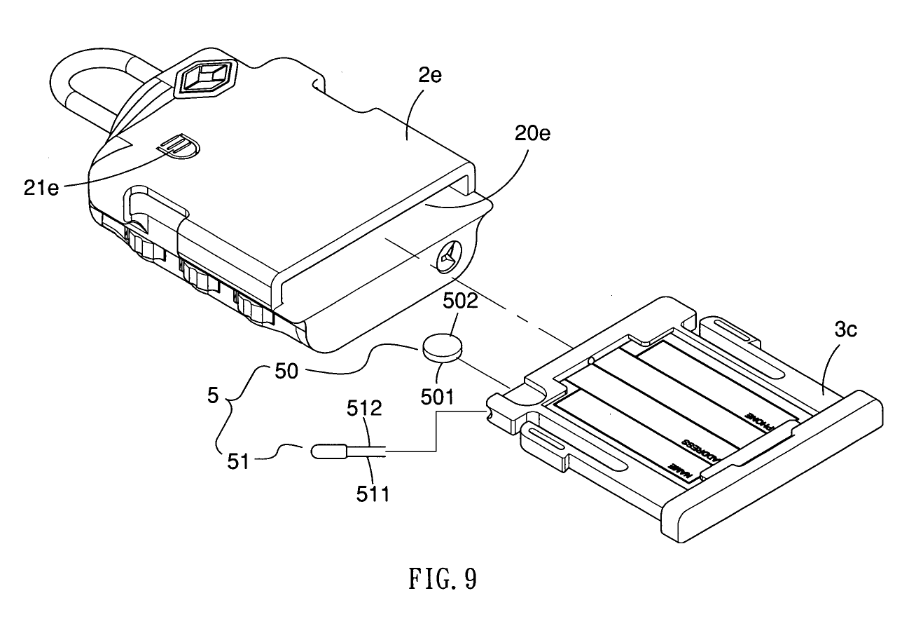

Referring to FIG. 8, the housing 2d has an inside formed with an insertion slot 20d and has a wall formed with a snapping hole 21d, and the carrier 3b is slidably inserted into the insertion slot 20d of the housing 2d and provided with an elastic snapping member 30b detachably snapped into the snapping hole 21d of the housing 2d.

Referring to FIGS. 9-11, the housing 2e has an inside formed with an insertion slot 20e and has a wall provided with an elastic push button 21e, and the carrier 3c is slidably inserted into the insertion slot 20e of the housing 2e, and an illumination assembly 5 is mounted on and supported by the carrier 3c. The illumination assembly 5 includes a battery 50 and a light emitting member 51. The battery 50 has a positive pole 501 and a negative pole 502.

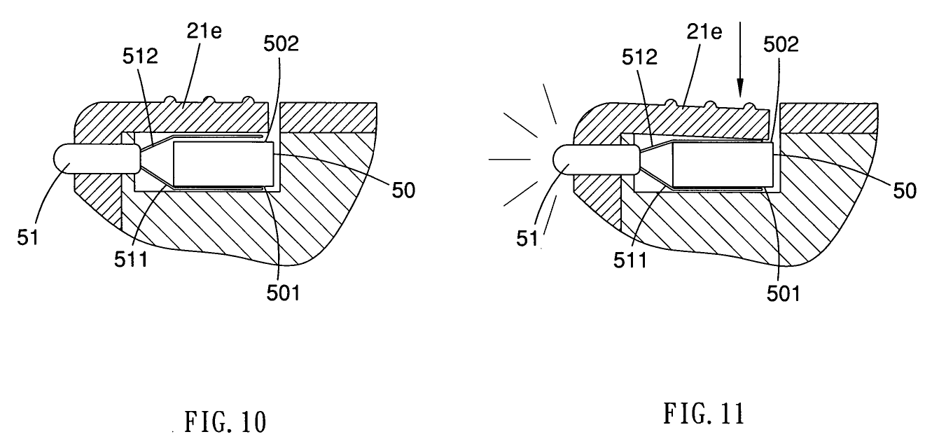

As shown in FIG. 10, the light emitting member 51 has a positive pole connecting leg 511 electrically connected to the positive pole 501 of the battery 50 and a negative pole connecting leg 512 spaced from the negative pole 502 of the battery 50 and located between the push button 21e of the housing 2e and the negative pole 502 of the battery 50.

As shown in FIG. 11, when the push button 21e of the housing 2e is pressed inward, the negative pole connecting leg 512 of the light emitting member 51 is pushed downward by the push button 21e of the housing 2e to touch the negative pole 502 of the battery 50, thereby electrically connecting the light emitting member 51 to the battery 50, so that the battery 50 supplies an electric power to the light emitting member 51 which lights to provide an illuminating function.

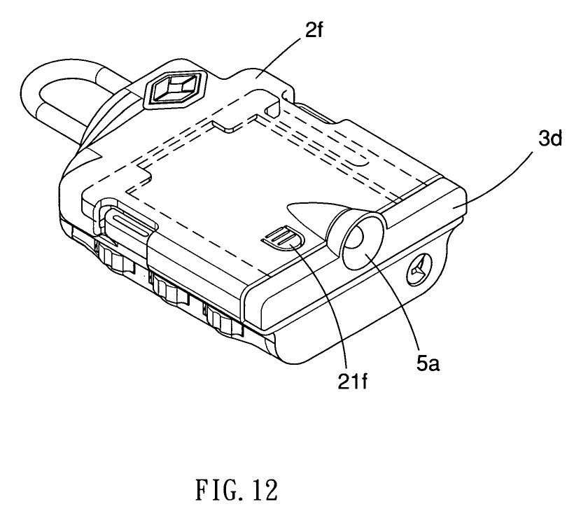

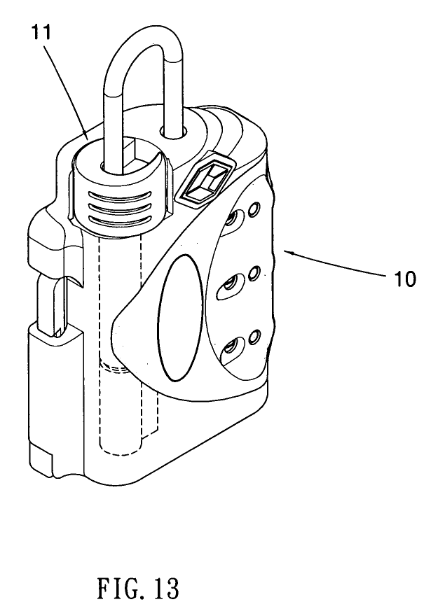

As shown in FIG. 12, when the elastic push button 21 f of the housing 2f is pressed, the illumination assembly 5a supported by the carrier 3d is operated to provide an illuminating function.

Referring to FIGS. 13-15, the lock device comprises a number lock mechanism 10 and a key lock mechanism 11.

As shown in FIG. 13, the lock device is disposed at a locked state.

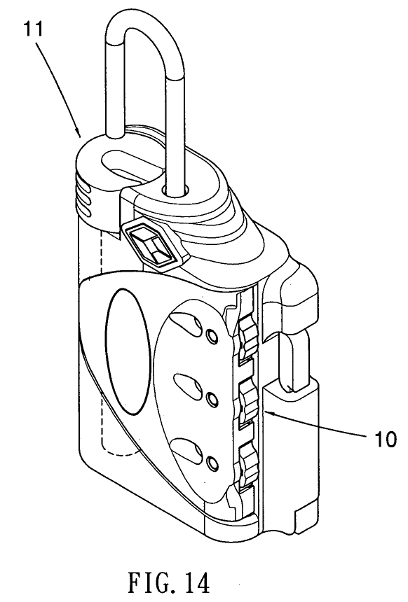

As shown in FIG. 14, the number lock mechanism 10 has a correct password, so that the lock device is disposed at an unlocked state. Thus, when the number lock mechanism 10 is disposed at a locked state, the carrier is locked, and when the number lock mechanism 10 is disposed at an unlocked state, the carrier is unlocked and released.

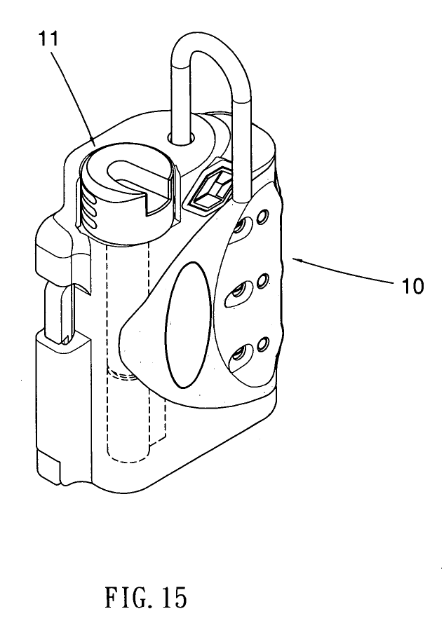

As shown in FIG. 15, the key lock mechanism 11 is opened by a key (not shown), so that the lock device is disposed at an unlocked state.

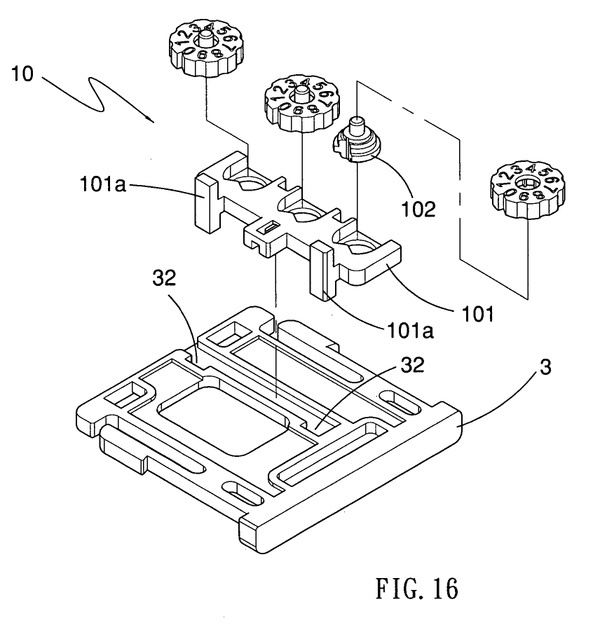

Referring to FIGS. 16-18, the carrier 3 has two locking grooves 32, and the number lock mechanism 10 includes a movable plate 101 provided with two protruding posts 101a, and a plurality of number wheel sets 102.

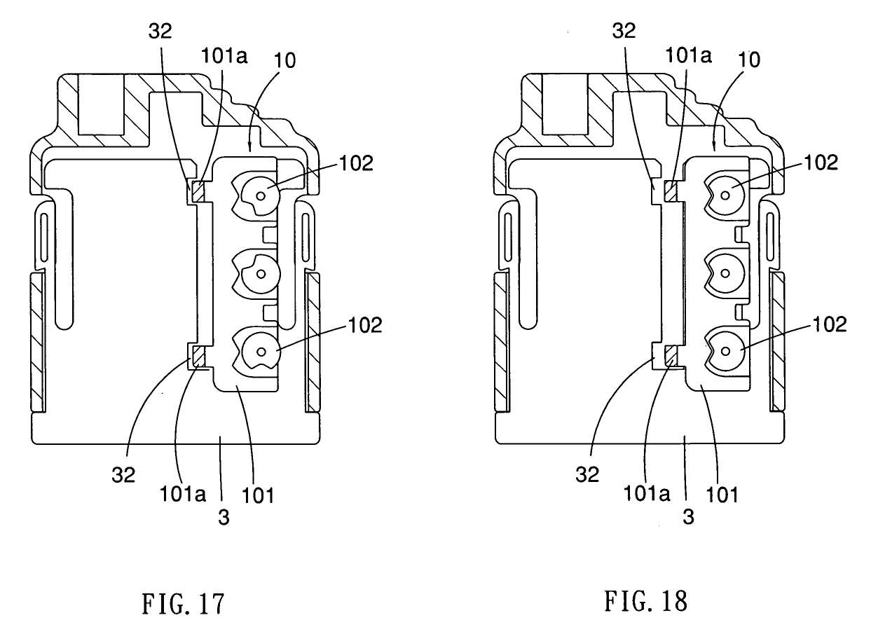

As shown in FIG. 17, the number lock mechanism 10 is disposed at a locked state, so that the carrier 3 is locked. At this time, the number wheel sets 102 are not rotated to have a correct password, so that the protruding posts 101a of the movable plate 101 are locked in the locking grooves 32 of the carrier 3.

As shown in FIG. 18, the number wheel sets 102 are rotated to have a correct password, so that the number lock mechanism 10 is disposed at an unlocked state. At this time, the movable plate 101 is pushed by an elastic member (not shown) to move rightward, so that the protruding posts 101a of the movable plate 101 are detached from the locking grooves 32 of the carrier 3, thereby releasing the carrier 3 from the movable plate 101.

Accordingly, the name card provided with a personal information is detachably mounted on the carrier so that the lock device has an identification function. In addition, the housing is made of a transparent material, so that the name card is directly viewable from the housing without having to remove the carrier from the housing. Further, a tiny article, such as a key or the like, is detachably mounted on the carrier so that the lock device has a storage function. Further, an illumination assembly is mounted on and supported by the carrier so that the lock device has an illuminating function. Further, when the number lock mechanism is disposed at a locked state, the carrier is locked, and when the number lock mechanism is disposed at an unlocked state, the carrier is unlocked and released.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lock device, comprising:
a lock body operable between a locked state and an unlocked state;
a housing mounted on a side of the lock body and having an inside formed with an insertion slot; and
a carrier slidably inserted into the insertion slot of the housing.

2. The lock device in accordance with claim 1, wherein the housing is made of a transparent material so that the housing is viewable.

3. The lock device in accordance with claim 2, wherein the carrier is provided with a personal information facing the housing.

4. The lock device in accordance with claim 2, further comprising a name card detachably mounted on the carrier and provided with a personal information facing the housing.

5. The lock device in accordance with claim 1, wherein the housing is formed with an elongated window.

6. The lock device in accordance with claim 5, wherein the carrier is provided with a personal information facing the elongated window of the housing.

7. The lock device in accordance with claim 5, further comprising a name card detachably mounted on the carrier and provided with a personal information facing the elongated window of the housing.

8. The lock device in accordance with claim 1, wherein the housing has two opposite sides each formed with a snapping hole, and the carrier has two opposite sides each formed with an elastic snapping member detachably snapped into the respective snapping hole of the housing.

9. The lock device in accordance with claim 1, wherein the housing has a wall provided with an elastic push button, and the carrier is provided with an elastic snapping member detachably snapped onto the wall of the housing and facing the push button of the housing.

10. The lock device in accordance with claim 1, wherein the housing has a wall formed with a snapping hole, and the carrier is provided with an elastic snapping member detachably snapped into the snapping hole of the housing.

11. The lock device in accordance with claim 1, further comprising an illumination assembly mounted on and supported by the carrier to provide an illuminating function.

12. The lock device in accordance with claim 11, wherein the housing has a wall provided with an elastic push button so that when the elastic push button of the housing is pressed, the illumination assembly supported by the carrier is operated to provide an illuminating function.

13. The lock device in accordance with claim 12, wherein the illumination assembly is spaced from and facing the elastic push button of the housing.

14. The lock device in accordance with claim 12, wherein the illumination assembly includes a battery having a positive pole and a negative pole, and a light emitting member having a positive pole connecting leg electrically connected to the positive pole of the battery and a negative pole connecting leg spaced from the negative pole of the battery and located between the push button of the housing and the negative pole of the battery.

15. The lock device in accordance with claim 1, wherein the carrier is locked when the lock body is disposed at the locked state and is unlocked when the lock body is disposed at the unlocked state.
